(19) United States
(12) Patent Application Publication
(10) Pub. No.: US 2006/0205390 A1
(43) Pub. Date: Sep. 14, 2006

(54) Inspirational messaging system and method of use

(76) Inventor: Patricia Sindler, Las Vegas, NV (US)

Correspondence Address: GREENBERG TRAURIG, 3773 HOWARD HUGHES PARKWAY, SUITE 500 NORTH, LAS VEGAS, NV, 89109, US

(21) Appl. No.: 11/075,582

(22) Filed: Mar. 8, 2005

(51) Int. Cl. H04Q 7/20; H04L 12/58

(52) U.S. Cl. 455/412.1; 455/466

(57) ABSTRACT

An automatic messaging system for sending inspirational messages is disclosed. The system utilizes existing cellular telephone networks and service providers. A telephone owner creates the messages with his or her telephone and stores the same therein. The telephone automatically transmits the messages at prescribed times to a receiving unit provided to an intended recipient of the inspirational messages. The receiving unit is formed in unique character shape (e.g., angel). The receiving unit comprises a display for displaying the messages received. Optionally a light source and speaker provide means for notifying the intended recipient that a message has been received. For example, the speaker may output an audio tone corresponding to a chime or bell or may output verbal tones.

### FIELD OF THE INVENTION

The embodiments of the present invention relate to an inspirational messaging system. More particularly, the embodiments relate to a system for sending daily inspirational messages to loved ones and those without loved ones.

### BACKGROUND

At no point during modern civilization has life been so complicated and time-consuming. Although advances in technology are meant to simplify lives, in reality all the new gadgets and gizmos seemingly complicate lives even more. As a result, people are so preoccupied with the daily hurdles of everyday life, that they are losing touch with their fellow man and woman. This disconnect is true among strangers, friends and family members.

At least in the United States, we as a free society have drifted away, both geographically and emotionally, from one another. Accordingly, family members do not stay in touch with regularity such that the family bond weakens over time. A perfect example is the plight of the elderly. We are so busy with our own lives that we place our own parents and grandparents in nursing homes. More disturbingly, we do not take the time to visit or contact our parents or grandparents in the homes where we have forced them to live out their remaining days.

Not surprisingly, the plight is even more disturbing for the elderly who have no family. These individuals, in many cases, have no significant personal contact during the winter of their lives. Similarly, those individuals requiring mental health care fail to receive any significant personal contact.

Unfortunately, this lack of personal contact causes the elderly, mentally ill and similarly positioned individuals to become depressed such that they feel like a burden on society.

There continues to be the need for a method or system for encouraging and inspiring the elderly, mentally ill and other disregarded individuals. The cellular telephone and pager technology we currently utilize in our daily lives is suitable for remedying the problems disclosed above.

### SUMMARY

The embodiments of the present invention comprise an automatic system for sending inspirational messages to those in need of such messages. In a first embodiment, the system utilizes current cellular telephone technology to send messages to a receiving device (e.g., pager) in the possession of the intended recipient. Ideally, the receiving device is in the form of an inspirational character (e.g., angel). In this embodiment, individuals wishing to send inspirational messages purchase the receiving device and provide it to the intended recipient. Then, the individual desiring to send the inspirational messages, engages a cellular telephone service provider (e.g., Cingular®) to automatically disseminate the inspirational messages of their choosing as frequently as desired. Pager, satellite and similar technology may also facilitate the embodiments of the present invention.

In this manner, the hustle and bustle of everyday life does not impede one's ability to provide some level of personal contact with those who need and want such contact. The content of the messages may be crafted by the sending individual and/or may be pre-established and offered by the cellular telephone service provider. The messages may be sent at random times and/or at selected times determined by the individual responsible for sending them.

Other features, variations and embodiments will become evident from the detailed description, drawings and claims set forth below.

### BRIEF DESCRIPTION OF THE DRAWINGS

FIG. 1 shows a block diagram of a first embodiment of the present invention utilizing a cellular telephone system;

FIGS. 2A and 2B show a message receiving device in the form of an angel; and

FIG. 3 shows a flow chart detailing the first embodiment of the present invention.

### DETAILED DESCRIPTION

The detailed description below relates to a inspirational messaging system. The description below focuses on the use of a cellular telephone network for facilitating the system. However, it will be understood by those skilled in the art that other signal sending systems, such as a pager system, may be used to facilitate the embodiments of the system.

The system disclosed below is intended to provide an automatic means for sending inspirational messages to those persons identified by an individual desirous of sending such messages. In other words, the complications of daily life require that the sender's message be sent without the sender having to remember to cause the message to be sent. Such a system is ideal for sending messages to loved ones, friends and even strangers who may not have friends or family. For example, many elderly find themselves alone in nursing homes without any personal outside contact. The system described herein is a easy means for providing the aforementioned elderly with an inspirational message intended to lift their spirits.

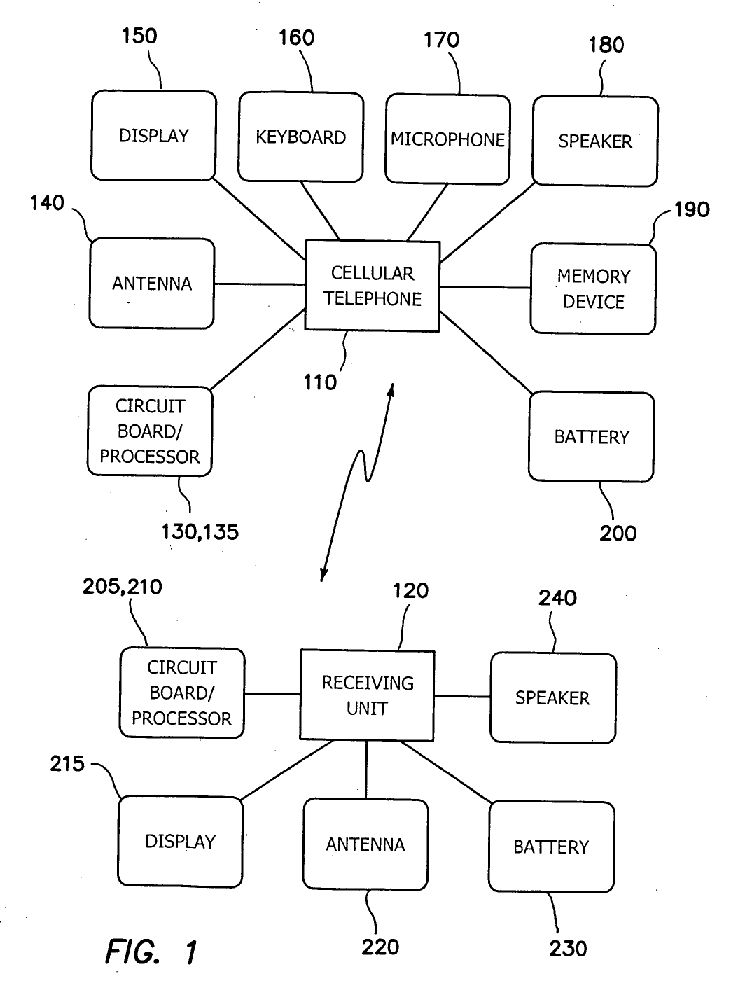

Reference is now made to the figures wherein like parts are referred to by like numerals throughout. FIG. 1 shows a block diagram of a first embodiment of an inspirational messaging system generally referred to by reference numeral 100. A sender's cellular telephone 110 and a receiving unit 120 are the basic components comprising the system. The sender's cellular telephone includes conventional components, including a circuit board 130 and corresponding processor 135, antenna 140, display 150, keyboard 160, microphone 170, speaker 180, memory device 190 and battery 200. The receiving unit 120 is a scaled down cellular telephone, including a circuit board 205 and corresponding processor 210, display 215, antenna 220, battery 230 and optionally speaker 240. In other words, it is not intended to permit the user to talk or otherwise communicate with a message sender.

Cellular telephone systems comprise a plurality of base stations arranged approximately one per every ten square miles. The base stations hand off calls as a subject cellular telephone enters one base station location and leaves another. This is why people are able to talk continuously on their cellular telephone as they change locations. The detailed specifics of the current cellular telephone networks is known to those skilled in the art and therefore does not need to be fully described herein.

In this first embodiment, the sender's cellular telephone 110 is responsible for causing an inspirational message to be sent. The circuit board 130 includes the microprocessor 135 which deals with command and control signaling with a closely located base station. The microprocessor 135 is pre-programmed to automatically send messages upon activation of such service. That is, the owner of the cellular telephone subscribes to the automatic message sending service through the cellular telephone service provider which then activates the service on the owner's telephone providing access to the cellular telephone service provider's cellular telephone network. Once the service is activated, the owner uses the cellular telephone's keyboard 160 to create the messages which are then stored in the cellular telephone's memory device 190. Depending on the service offered, the owner programs the times and frequency for sending the messages from his or her cellular telephone. Alternatively, random times maybe selected by the microprocessor 135 or related device (e.g., random number generator). Besides the microprocessor 135, it is conceivable that other chips on the telephone's circuit board may handle these functions as well.

In an alternative embodiment, a central transmission station affiliated with the cellular telephone service provider and cellular telephone network may send a signal to the owner's cellular telephone thereby causing the corresponding cellular telephone to send the stored messages. In this embodiment, the central station maintains owner accounts and corresponding cellular telephone identification information such that the central station is capable of contacting the owner's cellular telephone to instruct it to send the stored messages. In other words, the central station functions as the microprocessor 135 of the first embodiment, but it communicates with all cellular telephone owners subscribing to the automatic service.

In a manual embodiment, the owner of the cellular telephone causes the messages to be sent by pulling up the message from storage and pressing the send button on the cellular telephone. In this embodiment, the owner may receive notification, for example from the central station, the messages have not been sent for some pre-established time period (e.g., 24 hours). This reminder ensures that the owner sends the messages as desired. In another embodiment, the central transmission station stores pre-established messages (e.g., prayers) which the cellular phone user may access, retrieve through their cellular telephone and then send as desired.

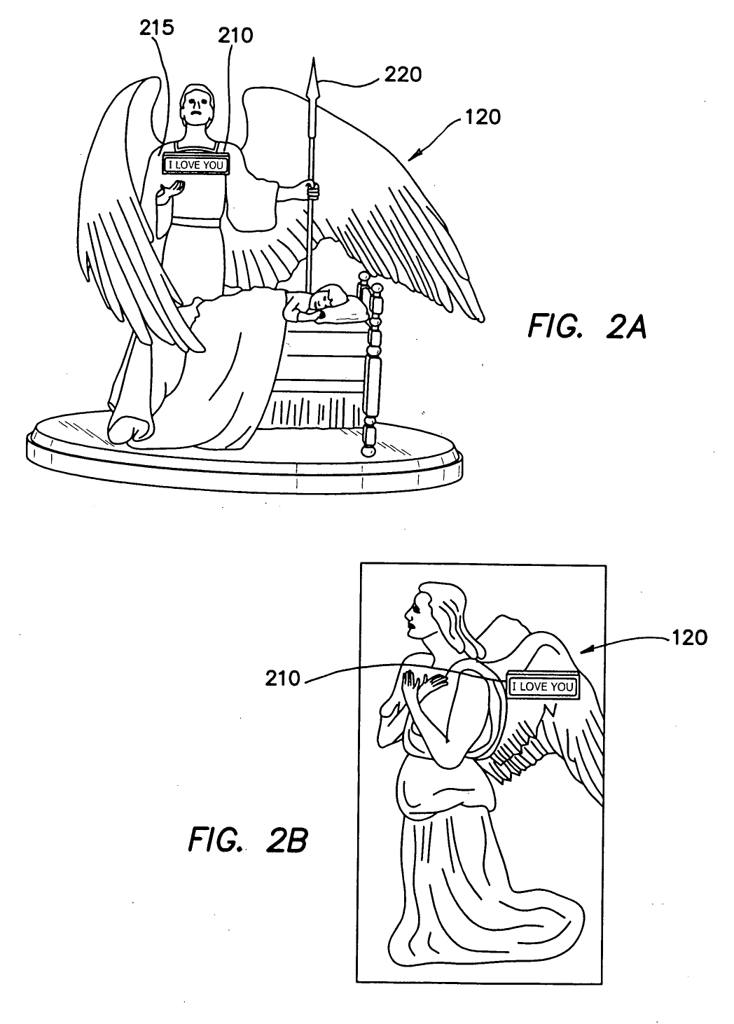

In the first embodiment as shown in FIGS. 2A and 2B, the receiving unit 120 is fabricated in the form of a inspirational character like a Buddha, Jesus or an angel. With such a design, the service may be promoted by the cellular telephone service provider under the fanciful name of “Heavenly Messengers” or similar unique names. Using the angel as an example, the angel character houses the processor 205, display 210, antenna 220 and battery 230. The display 210 may be a LCD display, graphic display or any other suitable display. Thus, once received, the inspirational messages are displayed on the display 210. The display 210 may be positioned anywhere on the receiving unit 120. To alert the receiver that a message has been received, the receiving unit 120 may include a light source 215 which illuminates upon receiving a message. In an angel embodiment, the light source 215 appears as a candle being held by the angel. The candle is then made to light via a small concealed LED upon receipt of a message. Optionally, the receiving unit 120 includes speaker 240. The speaker 240, in communication with the processor 205, may cause the message to be transmitted in an audio and/or verbalized format. For example, the receipt of a message may be accompanied by the sound of a mission bell, chime or similar peaceful sound. The speaker 240 also facilitates a reading of the message. In such an embodiment, software embedded in the microprocessor 205 is responsible for generating voice outputs corresponding to the message.

The receiving unit 120 may remain in a recipient's home, car or any other desired location. In this manner, the recipient is always capable of receiving a message.

While a inspirational type characters are disclosed above, any character attractive to the recipient may be utilized. For example, celebrities, athletes and other well-known characters may be utilized.

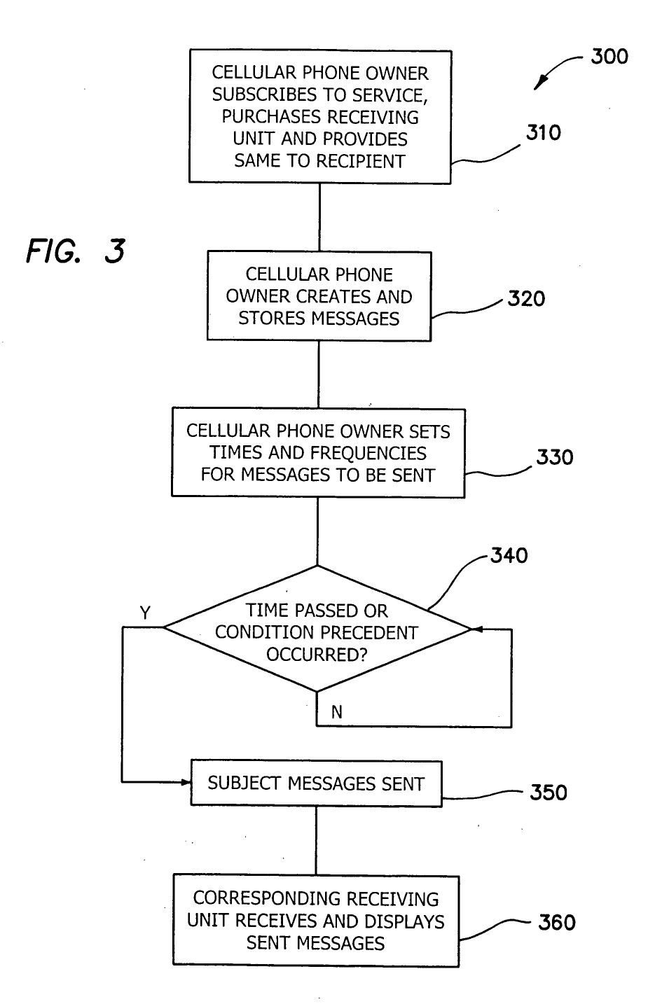

Now referring to FIG. 3, a flow chart 300 details the first embodiment of the present invention. At step 310, a cellular telephone owner subscribes to service, purchases a receiving unit and provides the receiving unit to the intended individual. The cellular telephone service provider shall determine the appropriate fee for said service. Most likely, the fee will be a flat monthly fee or a flat fee related to each message transmitted. Ideally, the individual receiving the messages is not financially impacted by the service. During the subscription process, the one or more receiving units are linked to the owner's telephone such that the messages are only sent to telephone numbers associated with corresponding receiving unit. Multiple receiving units may correspond to owner's telephone such that each receiving unit receives the same messages or different messages. At step 320, the telephone owner creates the messages with the telephone's keyboard and stores then therein. Alternatively and/or additionally, the telephone may be pre-programmed with suitable stored inspirational messages such as prayers. At step 330, the telephone owner sets the time periods for the messages to be transmitted. The time periods may be exact times, pre-established time periods in between transmissions and/or random transmission times during given time period (e.g., messages sent randomly once every 24 hours). At step 340, it is determined whether the pre-established time has passed or other condition precedent has occurred such that the one or more messages may be sent. If so, at step 350, the subject message is sent to the corresponding one or more receiving units. If not, the flow chart loops back to step 340 until the time passes or the condition precedent has occurred. At step 360, the corresponding receiving units receive the message and the processor causes the received message (or messages) to be displayed. Optionally, a light source may illuminate to notify the recipient that a message has been received. Also, optionally, a speaker verbalizes the received message. Along with the transmitted message, the identity of the sender is displayed so that the recipient knows who sent the inspirational message. Steps 340 and 350 are repeated until the owner unsubscribes from the service.

The messaging system disclosed herein is a novel means for sending family members, friends and even strangers well-wishes in a manner akin to flowers but with much less time invested.

Although the invention has been described in detail with reference to several embodiments, additional variations and modifications exist within the scope and spirit of the invention as described and defined in the following claims.

I claim:

1. An automatic messaging system comprising:
a message sending device;
one or more message receiving devices comprising a display and/or audio speaker; and
wherein, pursuant to pre-programmed instructions, said message sending device automatically sends one or more pre-established messages to said one or more message receiving devices which display said one or more messages on said display and/or cause the one or more received messages to be verbalized via said speaker.

2. The automatic messaging system of claim 1 wherein said messaging sending device is a cellular telephone.

3. The automatic messaging system of claim 2 wherein a user of said cellular telephone creates and stores said messages in a memory device of the cellular telephone.

4. The automatic messaging system of claim 2 wherein said cellular telephone causes said messages to be sent automatically.

5. The automatic messaging system of claim 2 wherein said user inputs information into the cellular telephone which determines the frequency with which the messages are automatically sent.

6. The automatic messaging system of claim 1 wherein said one or more message receiving devices are fabricated in the form of an angel.

7. The automatic messaging system of claim 1 wherein said message receiving devices further comprise a light source which illuminates in response to receiving a message.

8. The automatic messaging system of claim 1 further comprising a central transmission station which sends a signal to the message sending device triggering the message sending device to send a message.

9. The automatic messaging system of claim 8 wherein the message sending device is a cellular telephone.

10. The automatic messaging system of claim 8 wherein the central transmission station stores pre-established messages for retrieval by user's of the message sending device.

11. The automatic messaging system of claim 1 wherein responsive to receiving a message said one or more message receiving devices output an audio tone corresponding to chime or bell.

12. An automatic messaging system comprising:
a cellular telephone incorporating means for creating and storing one or more messages;
one or more message receiving units; and
wherein said stored one or more messages are automatically sent to corresponding ones of said message receiving units which display said messages on a message receiving unit display and/or cause the received message to be verbalized via a message receiving unit speaker.

13. The automatic messaging system of claim 12 wherein said cellular telephone further incorporates means for a user to determine a frequency with which said one or more messages are automatically sent to said one or more message receiving units.

14. The automatic messaging system of claim 12 wherein said message receiving unit takes the form of an angel.

15. The automatic messaging system of claim 12 wherein said receiving messaging unit further comprises a light source which illuminates in response to receiving a message.

16. The automatic messaging system of claim 12 further comprising a central transmission station which sends a signal to the cellular telephone causing the cellular telephone to send one or more of said messages.

17. The automatic messaging system of claim 16 wherein the central transmission station stores pre-established messages for retrieval by user's of the message sending device.

18. The automatic messaging system of claim 12 wherein responsive to receiving a message said one or more message receiving devices output an audio tone corresponding to chime or bell.

19. A method of automatically sending a message to a desired recipient comprising:
providing a message sending unit;
providing means for creating and storing one or more messages, said means incorporated on said message sending unit;
providing one or more message receiving units;
automatically causing said one or more messages to be sent to corresponding ones of said message receiving units; and
causing said message receiving unit to display and/or verbalize the received one or more messages.

20. The method of claim 19 wherein the message sending unit is a cellular telephone.

21. The method of claim 19 wherein the means for creating one or more messages comprises a keyboard.

22. The method of claim 19 further comprising providing means for establishing a frequency with which said one or more messages is sent, said means incorporated on said message sending unit.

23. The method of claim 19 further comprising forming said message receiving unit in a shape of an angel.

24. The method of claim 19 further comprising providing a light source for each of said message receiving units wherein said light source illuminates in response to receiving a message.

25. The method of claim 19 further comprising providing sending a signal from a central transmission station to the message sending unit thereby triggering the message sending unit to send a message.

26. The method of claim 25 wherein the central transmission station stores pre-established messages for retrieval by user's of the message sending device.

27. The method of claim 19 further comprising outputting an audio tone corresponding to chime or bell in response to receiving a message.
